(19) United States
(12) Patent Application Publication
(10) Pub. No.: US 2005/0066036 A1
(43) Pub. Date: Mar. 24, 2005

(54) Methods, systems and computer program products for facilitating the design and analysis of virtual networks based on total hub value

(76) Inventor: Neil Gilmartin, Atlanta, GA (US)

Correspondence Address: Philmore H. Colburn II;CANTOR COLBURN LLP, 55 Griffin Road South, Bloomfield, CT, 06002, US

(21) Appl. No.: 10/866,011

(22) Filed: Jun. 11, 2004

Related U.S. Application Data
(63) Continuation-in-part of application No. 10/666,069, filed on Sep. 19, 2003.

(51) Int. Cl. G06F 15/173

(52) U.S. Cl. 709/226; 709/238

(57) ABSTRACT

A method for facilitating the design and assignment of virtual networks, such as virtual local area networks (VLANs). The method includes receiving a request to add a new node to a base virtual network including a number of base nodes. A plurality of potential routes are determined between the new access node and the base nodes. For each potential route, a virtual network total hub value is determined. The virtual network total hub value is the sum of a hub value for each base node and a hub value for the new node. The hub value is determined for a node in response to bandwidth received at the node multiplied by a number of trunks traversed in reaching the node. One of the potential routes yielding the minimum virtual network total hub value is selected.

### CROSS REFERENCE TO RELATED APPLICATIONS

This application is a continuation-in-part of U.S. patent application Ser. No. 10/666,069 filed Sep. 19, 2003, the entire contents of which are incorporated herein by reference.

### FIELD OF THE INVENTION

The present disclosure relates generally to facilitating the design and assignment of virtual networks and in particular, to a method of designing new virtual networks and adding access ports to existing virtual networks.

### BACKGROUND OF THE INVENTION

Computer networks carry data between various devices. The data may be carried in connection-based links, such as the virtual circuits in an Asynchronous Transfer Mode (ATM) network. Data may also be carried between devices in network segments where data is broadcast to all of a plurality of devices on the segment via a broadcast-type medium. An example of the latter is an Ethernet network. It is typically convenient to set up local area networks (LANs) using a broadcast type medium over which devices can share data.

In some circumstances, for example, where a LAN is required to connect devices that are geographically distant from one another, the LAN may be broken into separate segments. Within each segment, devices (e.g., switches) can exchange data by way of a broadcast-type medium. The segments may be connected to one another by way of connection-based links such as physical transport lines. Such a LAN may be referred to as a virtual LAN (VLAN). A VLAN may be thought of as a logical web of connections over physical transports.

Metro-Ethernet networks are based on VLANs within the Ethernet network of a given metropolitan area. In order to provide this service to a customer, a service provider must design and assign a virtual network within the physical network for the customer. The VLAN creator is typically supplied with a VLAN name, a class of service (COS) for the VLAN and a certain number of access ports on the service provider Ethernet switches with the bandwidth (BW) required for each port. After the initial creation of the VLAN, access ports may be added or removed from the VLAN. Currently, the design of the VLAN and the assignment of access ports is performed manually with expert technicians attempting to take many constraints into consideration (e.g., BW required for each port, COS, layout of switches, layout of trunks, no loops allowed in VLAN, topology of VLAN). As VLANs become larger and more complex it becomes difficult and time consuming for technicians to manually design and assign VLANs.

### SUMMARY

Exemplary embodiments of the present invention include a method for facilitating the design and assignment of virtual networks, such as VLANs. The method includes receiving a request to add a new node to a base virtual network including a number of base nodes. A plurality of potential routes are determined between the new access node and the base nodes. For each potential route, a virtual network total hub value is determined. The virtual network total hub value is the sum of a hub value for each base node and a hub value for the new node. The hub value is determined for a node in response to bandwidth received at the node multiplied by a number of trunks traversed in reaching the node. One of the potential routes yielding the minimum virtual network total hub value is selected.

Other exemplary embodiments of the present invention include a system for facilitating the design and assignment of virtual networks. The system includes an input for receiving a request to add a new node to a base virtual network including a number of base nodes. A processor determines a plurality of potential routes between said new node and said base nodes, wherein for each potential route, the processor determines a virtual network total hub value. The virtual network total hub value is the sum of a hub value for each base node and a hub value for the new node. The hub value is determined for a node in response to bandwidth received at the node multiplied by a number of trunks traversed in reaching that node. The processor selects one of the potential routes yielding the minimum virtual network total hub value

Further exemplary embodiments of the present invention include a computer program product for facilitating the design and assignment of virtual networks, the computer program product comprising a storage medium readable by a processing circuit and storing instructions for execution by the processing circuit for implementing a method. The method includes receiving a request to add a new node to a base virtual network including a number of base nodes. A plurality of potential routes are determined between the new access node and the base nodes. For each potential route, a virtual network total hub value is determined. The virtual network total hub value is the sum of a hub value for each base node and a hub value for the new node. The hub value is determined for a node in response to bandwidth received at the node multiplied by a number of trunks traversed in reaching the node. One of the potential routes yielding the minimum virtual network total hub value is selected.

Other systems, methods and/or computer program products according to exemplary embodiments will be or become apparent to one with skill in the art upon review of the following drawings and detailed description. It is intended that all such additional systems, methods, and/or computer program products be within the scope of the present invention, and be protected by the accompanying claims.

### BRIEF DESCRIPTION OF THE DRAWINGS

Referring to the exemplary drawings wherein like elements are numbered alike in the several FIGURES:

FIG. 1 is a block diagram of an exemplary system for facilitating the design and assignment of Ethernet VLANs in accordance with exemplary embodiments of the present invention;

FIG. 2 is a flow diagram of an exemplary process for facilitating the design and assignment of Ethernet VLANs in accordance with exemplary embodiments of the present invention;

FIG. 3 is a block diagram of switches and physical transport lines that may be utilized in exemplary embodiments of the present invention;

FIG. 4 is a block diagram of an exemplary VLAN that may be implemented utilizing the switches and physical transport lines depicted in FIG. 3;

FIG. 5 is a flow diagram of an exemplary process for developing a base VLAN in accordance with exemplary embodiments of the invention;

FIG. 6 is a flow diagram of an exemplary process for adding a node to an existing VLAN in accordance with exemplary embodiments of the invention; and

FIG. 7 is a block diagram of an exemplary VLAN that may be implemented utilizing the switches and physical transport lines.

### DETAILED DESCRIPTION OF THE INVENTION

Exemplary embodiments of the present invention facilitate the design and assignment functions for creating new virtual networks and adding access ports to existing virtual networks. Although the description below is directed to the design and assignment of VLANs within LANs, it should be appreciated that the invention is not so limited but is applicable to the design of any logical network within a physical network.

According to exemplary embodiments, trunks, or physical transport lines, connecting the switches containing access ports in a VLAN are selected by taking a number of assumptions and constraints into account. The service provider Ethernet topology (e.g., the layout of switches and trunks that connect them together) is one such constraint. The Ethernet network may be of any topological configuration such as hub and spoke, mesh or hybrid. A given VLAN instance on the network is assumed to be of a tree structure. This means that there are not any loops in the VLAN configuration (i.e., there can never be two different paths between any two points in the VLAN). A consequence of not having loops in the VLAN configuration is that for any given trunk in the VLAN, all access ports in the VLAN are divided into two non-overlapping sets. This in turn allows capacity management to be based on a least contribution algorithm. In addition, as new access ports are added to a VLAN, the tree structure is assured by the system by never allowing any new path added to continue beyond the first point of contact with the existing VLAN. Exemplary embodiments of the present invention receive a VLAN name, a COS and two or more access ports to be connected into the VLAN. If the VLAN does not currently exist, the first two ports are connected with a least cost path between them to form the base VLAN. Once a VLAN exists, access ports are connected into the VLAN with a least cost path to other access ports in the VLAN. The cost of a path may be determined by adding the cost of each trunk in the path.

Exemplary embodiments of the present invention calculate hub values and total hub values. The hub values are associated with each switch in the VLAN. The total hub value is the sum of the hub values for all the switches in the VLAN. The total hub value is calculated by exemplary embodiments of the present invention whenever more than one path is possible from a new access port into the VLAN. By minimizing this value, the VLAN is kept efficient and traffic transport is economized.

Exemplary embodiments of the present invention operate in the context of an operating support system (OSS) that manages metro-Ethernet services. The OSS system may provide the context of network intelligence and capacity tracking counters and control parameters that govern the logic of the design and assign algorithm. In exemplary embodiments of the present invention, the OSS has a database of network elements and trunks connecting them so that it can determine all of the network elements connected to any given network element. In addition, the OSS has a database of existing VLANs such that the VLAN names are unique across the region and each existing VLAN has an accessible list of network elements already in the connection paths of that VLAN. In addition, the OSS will provide capacity numbers to exemplary embodiments of the present invention to determine if there is enough available bandwidth on the trunk to add an access port with a specified bandwidth requirement and enough capacity on the switch to add another access port.

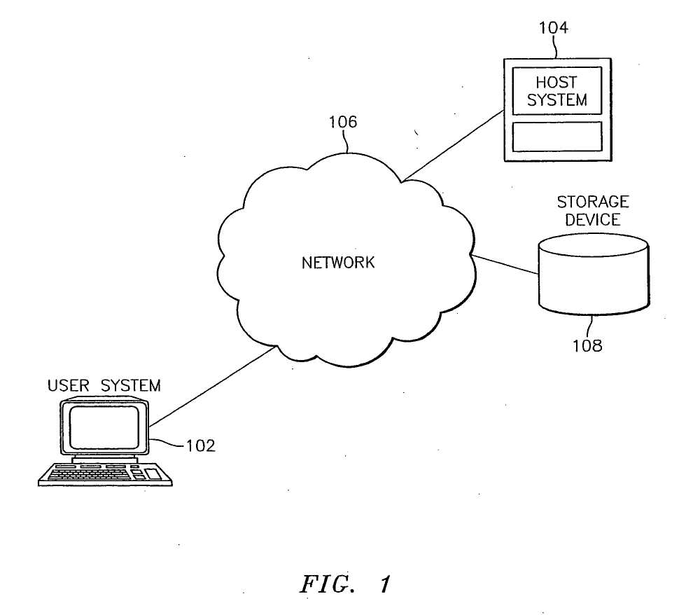

FIG. 1 is a block diagram of an exemplary system for facilitating the design and assignment of Ethernet VLANs in accordance with exemplary embodiments of the present invention. The exemplary system includes a host system 104 for executing an Ethernet VLAN design and assignment application. The system in FIG. 1 also includes one or more user systems 102 through which VLAN technicians located at one or more geographic locations may contact the host system 104 to initiate the execution of the design and assignment application. In exemplary embodiments of the present invention, the host system 104 executes the design and assignment application and the user system 102 is coupled to the host system 104 via a network 106. In alternate exemplary embodiments, the user system 102 is directly connected to the host system 104. Each user system 102 may be implemented using a general-purpose computer executing a computer program for carrying out the processes described herein. The user system 102 may be a personal computer (e.g., a lap top, a personal digital assistant) or a host attached terminal. If the user system 102 is a personal computer, the processing described herein may be shared by a user system 102 and the host system 104 (e.g., by providing an applet to the user system 102).

The network 106 may be any type of known network including, but not limited to, a wide area network (WAN), a local area network (LAN), a global network (e.g. Internet), a virtual private network (VPN), and an intranet. The network 106 may be implemented using a wireless network or any kind of physical network implementation known in the art. A user system 102 may be coupled to the host system 104 through multiple networks (e.g., intranet and LAN) so that not all user systems 102 are coupled to the host system 104 through the same network. One or more of the user systems 102 and the host system 104 may be connected to the network 106 in a wireless fashion.

The storage device 108 depicted in FIG. 1 may be implemented using a variety of devices for storing electronic information. It is understood that the storage device 108 may be implemented using memory contained in the host system 104 or it may be a separate physical device. The storage device 108 is logically addressable as a consolidated data source across a distributed environment that includes a network 106. The physical data may be located in a variety of geographic locations depending on application and access requirements. Information stored in the storage device 108 may be retrieved and manipulated via the host system 104. The storage device 108 includes interim data utilized to perform the design and assignment of an Ethernet VLAN as well as the resulting VLAN layout. In addition, the storage device 108 includes access to operational data such as a database of network elements and trunks, a database of existing VLANs and the network elements associated with the VLANs, and capacity data for the trunks and switches. The storage device 108 may also include other kinds of data such as information concerning the creation and update of the VLAN layouts (e.g., date, time of creation/update and technician identification). In exemplary embodiments of the present invention, the host system 104 operates as a database server and coordinates access to application data including data stored on storage device 108. Access to data contained storage device 108 may be restricted based on user characteristics.

The host system 104 depicted in FIG. 1 may be implemented using one or more servers operating in response to a computer program stored in a storage medium accessible by the server. The host system 104 may operate as a network server (e.g., a web server) to communicate with the user system 102. The host system 104 handles sending and receiving information to and from the user system 102 and can perform associated tasks. The host system 104 may reside behind a firewall to prevent unauthorized access to the host system 104 and enforce any limitations on authorized access. A firewall may be implemented using conventional hardware and/or software as is known in the art.

The host system 104 may also operate as an application server. The host system 104 executes one or more computer programs to facilitate the design and assignment of an Ethernet VLAN. One or more application programs within the host system 104 share information to support the design and assignment process. The processing of the design and assignment application may be shared by a user system 102 and the host system 104 by providing an application (e.g., a java applet) to the user system 102. As previously described, it is understood that separate servers may be utilized to implement the network server functions and the application server functions. Alternatively, the network server, the firewall, and the application server may be implemented by a single server executing computer programs to perform the requisite functions.

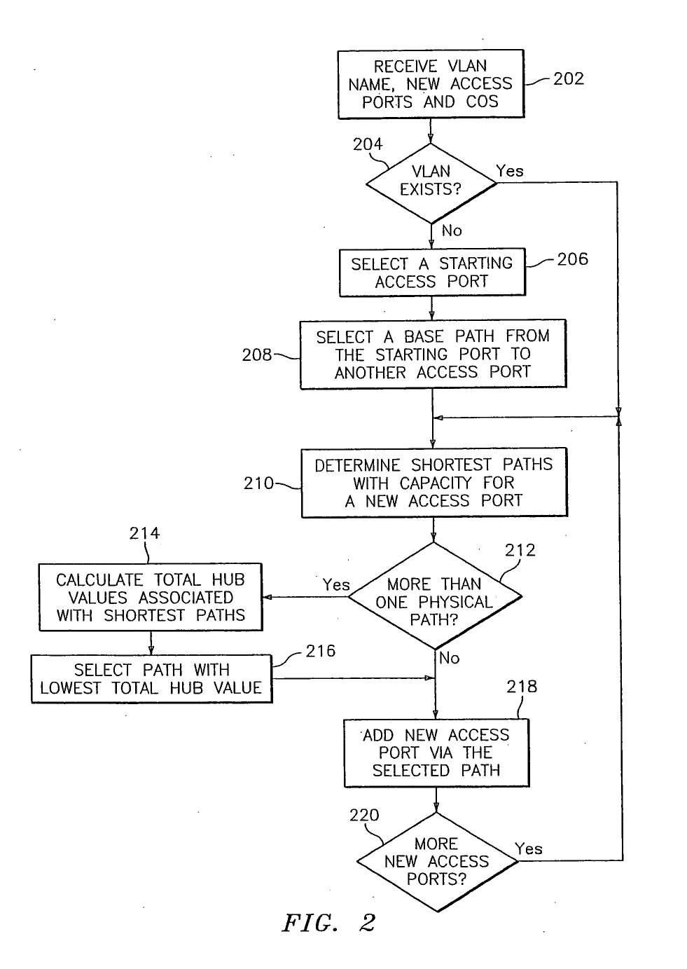

FIG. 2 is a flow diagram of an exemplary process for facilitating the design and assignment of Ethernet VLANs in accordance with exemplary embodiments of the present invention. At step 202, a VLAN name, COS and two or more access ports are received. At step 204, it is determined if the VLAN already exists. In exemplary embodiments of the present invention this may be performed by accessing an operational database that includes a listing of currently existing VLANs. In addition, the operational database may include the network elements (e.g. switches) and access ports (including bandwidths) within each VLAN. If the VLAN exists, as determined at step 204, then step 210 is performed to add the access port(s) to the VLAN. The access ports are physically located on switches. Otherwise, if the VLAN does not currently exist, step 206 is performed to start creating a VLAN from the access ports received at step 202. At step 206, a starting access port is selected. Unless otherwise instructed, any access port may be selected from the access ports received at step 202 to be the starting access port. Next, at step 208, a base path is selected from the starting access port to another access port received at step 202. A list of potential paths (including a list of switches) is created, by listing the shortest path (least number of hops from access port to access port) from the starting access port to a subset of the access ports received at step 202. A pre-selected number (e.g., up to 4) of the access ports located on different switches may be randomly selected to be included in the subset or the subset may be selected based on other criteria. The longest path from the starting access port to any of the subset of access ports is then selected for a base path for the VLAN. If there are one or more longest path candidates, any of them may be selected as the base path for the VLAN. The bandwidth on one side and the other of each trunk in the base path is calculated. In addition, the contribution of the base VLAN to each trunk is calculated and capacity counters are updated.

Next, starting at step 210, a loop is performed to add each new access port received at step 202 to the existing VLAN. At step 210, a list of the possible physical paths from the new access port to a switch in the VLAN is created. The list only contains those physical transport lines and switches that contain capacity for the new access port. The capacity may be verified against data from an operational support system for tracking capacity. Next, at step 212, it is determined if there is more than one physical path from the new access port to a switch contained in the VLAN. If there is more than one physical path, then step 214 is performed to calculate the total hub value associated with each of these physical paths. At step 216, the path resulting in the lowest total hub value is selected. The new access port is connected to the VLAN via the selected path at step 218. In addition, the bandwidth (BW) contribution is calculated and capacity is checked. If more access ports remain to be connected into the VLAN, as determined at step 220, then the process of adding an access port, starting at step 210 is repeated. If there are no more access ports to connect into the VLAN, as determined at step 220, then the processing is complete. When the design and assignment of the VLAN has been completed, the design may be transmitted to an operational support system to implement the design. Implementing may include provisioning the VLAN and making it available to the customer.

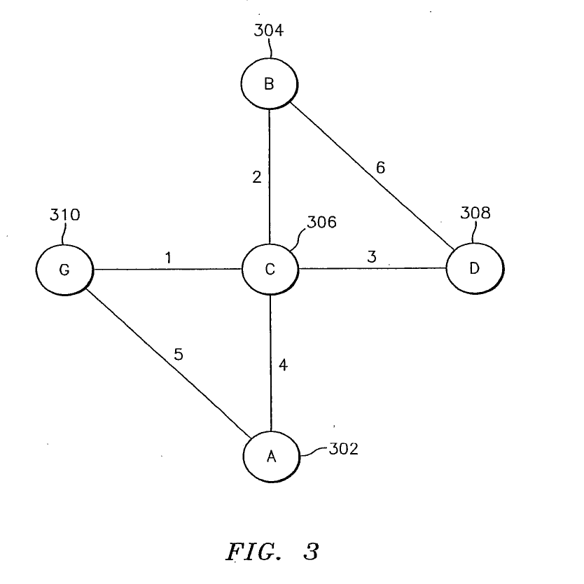

In the following example, a simplified Ethernet VLAN is created using exemplary embodiments of the present invention. The example is simplified to show how exemplary embodiments of the present invention may operate, however, a typical Ethernet VLAN may include twenty or more access ports. FIG. 3 is a block diagram of switches and physical transport lines that may be utilized in exemplary embodiments of the present invention. The block diagram includes switch A 302, switch B 304, switch C 306, switch D 308 and switch G 310 connected via various paths by physical transport lines labeled “1” through “6.”

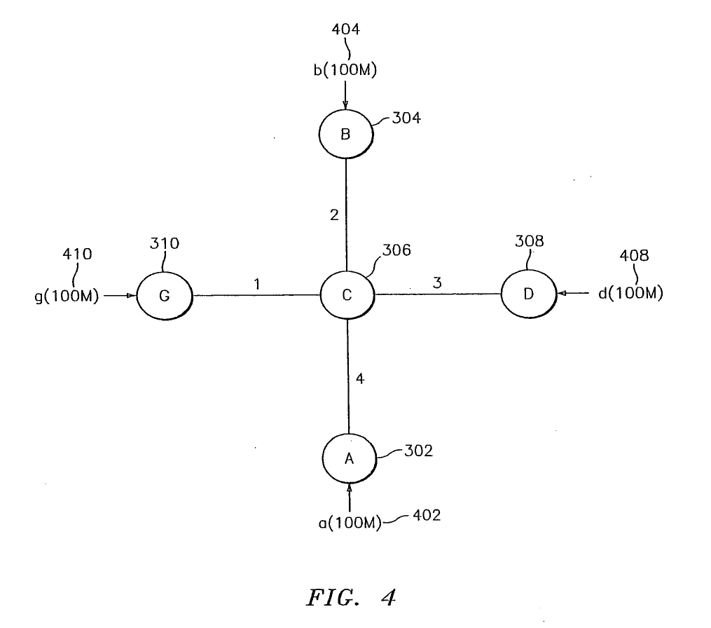

In this example, it is assumed that that VLAN is new and that the input data includes a VLAN name “Sample”, a COS (e.g., Best Effort, Committed BW, Priority Plus) and four access ports as shown in FIG. 4: access port “a” 402 located at switch A 302 with a 100 Megabyte (M) bandwidth; access port “b” 404 located at switch B 304 with a 100 M bandwidth; access port “d” 408 located at switch D 308 with a 100 M bandwidth; access port “g” 410 located at switch G 310 with a 100 M bandwidth. A starting access port, access port “g” 410 is selected at random (see step 206 in FIG. 2). Next, a base path from the starting access port to another access port is selected (see step 208 in FIG. 2). Paths from access port “g” 410 to the other access ports include: switch G 310 to switch A 302 (GA); switch G 310 to switch C 306 to switch B 304 (GCB); and switch G 310 to switch C 306 to switch D 308 (GCD). Because there are two paths that include three switches (GCB, GCD), one of them “GCD” is selected at random as a base path for the Sample VLAN.

Now, each of the other access ports is connected into the Sample VLAN (see step 210 in FIG. 2). Access port “a” 402 is randomly selected to be connected to the sample VLAN first. Physical transport line “4” connects access port “a” 402 to switch C 306 which is included in the VLAN. In addition, physical transport line “5” connects access port “a” 402 to switch G 310 which is also included in the VLAN. These are the only two physical transport lines out of the switch A 302 where access port “a” 402 is located. The next hop on both of these transport lines is a VLAN network element so a decision about which to use is made by calculating the total hub value associated with each possibility (see step 214 in FIG. 2) if both have the capacity to handle a BW of 100 M for the request COS. The total hub value associated with connecting switch A 302 to switch G 310 (AG) may be calculated as follows:

| Switch | Current Hub Value | Additional Value | New Hub Value |
|---|---|---|---|
| G | 200 (DCG) | 100 (AG) | 300 |
| C | 200 (GC, DC) | 200 (AGC) | 400 |
| D | 200 (GCD) | 300 (AGCD) | 500 |

| | |
|---|---|
| TOTAL HUB VALUE for AG | 1200 |

Similarly, the total hub value associated with connecting switch A 302 to switch C 306 (AC) may be calculated as follows:

| Switch | Current Hub Value | Additional Value | New Hub Value |
|---|---|---|---|
| G | 200 (DCG) | 200 (ACG) | 400 |
| C | 200 (GC, DC) | 100 (AC) | 300 |
| D | 200 (GCD) | 200 (ACD) | 400 |

| | |
|---|---|
| TOTAL HUB VALUE for AC | 1100 |

Therefore, because it results in a lower total hub value, the path from switch A 302 to switch C 306 (AC) is selected for access port “a” 402. This path is then added to the VLAN (see step 218 in FIG. 2).

One more access port remains to be connected to the Sample VLAN (see step 220 in FIG. 2). The process of connecting access port “b” 404 to the VLAN begins by determining the shortest path with capacity to connect into the existing VLAN (see step 210 in FIG. 2). Physical transport line “6” connects access port “b” 404 to switch D 308 which is included in the VLAN. In addition, physical transport line “2” connects access port “b” 404 to switch C 306 which is included in the VLAN. These are the only two physical transport lines out of the switch B 304 where access port “b” 404 is located. The next hop on both of these transport lines is a VLAN network element so a decision about which to use is made by calculating the total hub value associated with each possibility (see step 214 in FIG. 2) if both have capacity to handle a BW of 100 M for the requested COS. The total hub value associated with connecting switch B 304 to switch D 308 (BD) may be calculated as follows:

| Switch | Current Hub Value | Additional Value | New Hub Value |
|---|---|---|---|
| G | 400 (DCG, ACG) | 300 (BDCG) | 700 |
| C | 300 (GC, AC, DC) | 200 (BDC) | 500 |
| D | 400 (GCD, ACD) | 100 (BD) | 500 |
| A | 400 (GCA, DCA) | 300 (BDCA) | 700 |

| | |
|---|---|
| TOTAL HUB VALUE for BD | 2400 |

Similarly, the total hub value associated with connecting switch B 304 to switch C 306 (BC) may be calculated as follows:

| Switch | Current Hub Value | Additional Value | New Hub Value |
|---|---|---|---|
| G | 400 (DCG, ACG) | 200 (BCG) | 600 |
| C | 300 (GC, DC, AC) | 100 (BC) | 400 |
| D | 400 (GCD, ACD) | 200 (BCD) | 600 |
| A | 400 (GCA, DCA) | 200 (BCA) | 600 |

| | |
|---|---|
| TOTAL HUB VALUE for BC | 2200 |

Therefore, because it results in a lower total hub value, the path from switch B 304 to switch C 306 (BC) is selected for access port “b” 404. This path is then added to the VLAN (see step 218 in FIG. 2). FIG. 4 is a block diagram of the resulting exemplary VLAN that may be implemented utilizing exemplary embodiments of the present invention with the switches and physical transport lines depicted in FIG. 3.

Other exemplary embodiments of the present invention include receiving a switch that is designated as the hub switch as part of the input to the process depicted in FIG. 2. When a hub switch is designated, the connection of each access port includes finding the shortest available path from the switch associated with the access port to the hub switch. Otherwise, the processing is similar to that described in reference to FIG. 2. In other alternate exemplary embodiments of the present invention, the access ports require different BWs and this is taken account in determining the hub value when connecting a new access port. For example, if the BW of a particular access port is 200 M, then each hop from that access port would count as 200 in determining the hub values.

Other alternate exemplary embodiments may reflect different costs associated with each hop, or trunk, between switches. These may be factored into the determination of the paths utilized by a VLAN, resulting in selection of least cost paths rather than shortest paths. Different costs may be assigned to trunks to encourage the use of new technology that may be less expensive or conversely to recoup the additional costs that may be associated with a higher cost connection. Alternatively, costs may be increased on old technology that the service provider is attempting to phase out. The way that the costs are assigned to hops may be utilized to encourage the use of particular transport lines and to discourage the use of other transport lines.

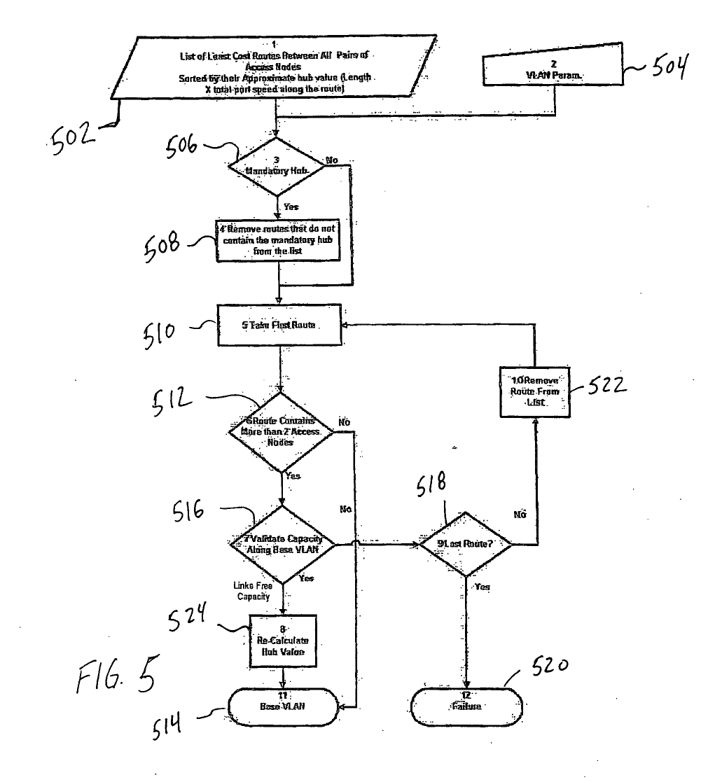

Additional embodiments of the invention apply alternate techniques to the generation of the base VLAN and the addition of nodes to the base VLAN. FIG. 5 is a flow diagram of an exemplary process for developing a base VLAN in accordance with exemplary embodiments of the invention. The process may be implemented by the system of FIG. 1. The process begins at step 502 where a list of least cost routes between all pairs of access nodes is developed. The list is sorted by approximate hub value (from lowest to highest) which is defined as the length of the route (e.g., the number of switch hops) times the total bandwidth or port speed along the route.

At step 504, which is independent of step 502, any VLAN parameters are considered. Exemplary VLAN parameters include the designation of a mandatory hub. At step 506, it is determined if any hubs have been designated as mandatory by the VLAN parameters. If so, any routes that do not include the mandatory hub are removed from the list of routes at step 508. Once routes that do not include the mandatory hub are removed, or if no mandatory hubs exist, flow proceeds to step 510 where the first route in the list of routes is selected. This route has the lowest approximate hub value.

At step 512, it is determined whether the selected route contains more than 2 nodes. If not, flow proceeds to step 514 where this two node route is selected as the base VLAN. If the route has more than two nodes, flow proceeds to step 516 where it is determined if the route has sufficient available bandwidth capacity to carry VLAN traffic. If not, flow proceeds to step 518 where, if this is the last route, a failure is indicated at step 520. If this is not the last route, this route is removed from the list of routes at step 522 and the next route is selected at step 510.

If the route has available capacity at step 516, the flow proceeds to step 524 where the hub values for each node are re-calculated and stored in a database (e.g., storage device 108). This route defines the base VLAN as indicated at step 514.

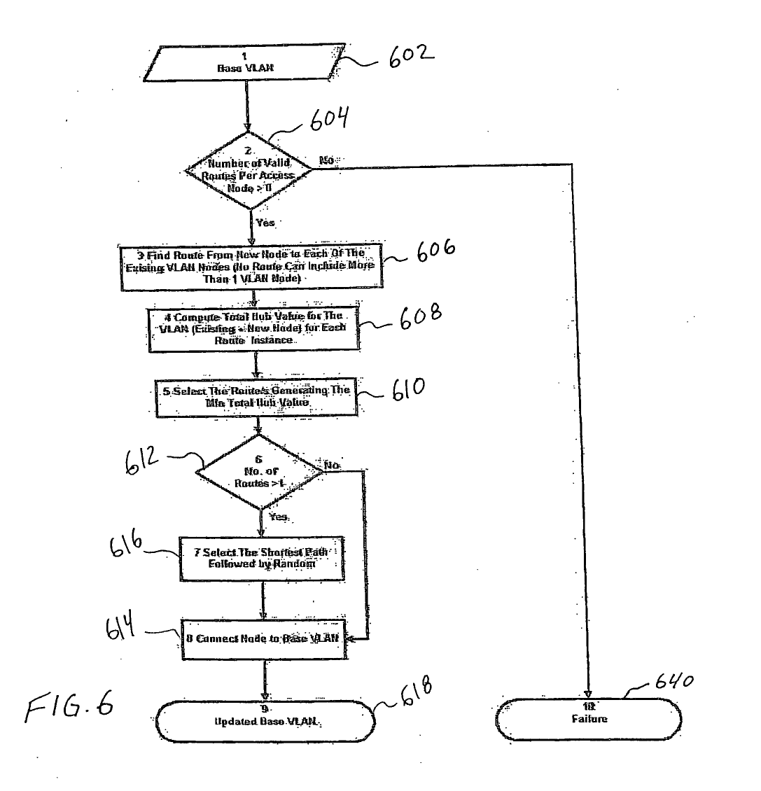

FIG. 6 is a flow diagram of an exemplary process for adding a node to an existing VLAN in accordance with exemplary embodiments of the invention. This process utilizes total hub value for the entire VLAN as a metric in determining where to add a new node to the base VLAN rather than the least cost path described above. The node may be an access node or an aggregation node, with the example in FIG. 6 being an access node. The process begins at step 602 with retrieving the base VLAN.

At step 604, it is determined whether there are any valid routes between the new access node and the nodes in the base VLAN. The validity of the route may be based on a number of factors. For example, the route needs to have the available bandwidth capacity to accommodate the requested connection from a new node. Other factors may be utilized such as using trunks dedicated to the requester, excluding trunks dedicated to others, selecting trunks that are easily managed, etc. Thus, the validity of the route may be based on a variety of factors. If no valid route is found between the new access node and the base VLAN, then the process cannot be completed. If no connection can be established, the process terminates in a failure at step 604.

If valid routes exist, then each route is found at step 606, with the condition that no route can include more than one VLAN node. That is, each connection from the new access node the base VLAN is a single trunk or hop. At step 608, the total hub value for the VLAN is computed for each potential connection between the new access node and the base VLAN. As described in further detail herein, the total hub value is the sum of each hub value in the VLAN, including the hub value of the new access node. The hub value for a node is computed as the sum of all port bandwidth times the number of hops to arrive at that node. Thus, if a node has three ports with bandwidth requirements of 10, 20 and 30, the bandwidth used for calculating the hub value is consolidated to 60. This facilitates calculating the hub values and the total hub value.

At step 610, the route(s) having the minimum total hub value are selected and at step 612 it is determined whether more than one route exists having the minimum total hub value. In other words, it is determined whether two or more routes have the same minimum total hub value. If only one route exists with the minimum total hub value, then this route is selected as the connection for the new access node and connected to the base VLAN at step 614. If two or more routes exist with the same minimum total hub value, then one route is selected at random at step 616 and then connected to the base VLAN at step 614. The base VLAN is then updated at step 618 to reflect the addition of a new access node.

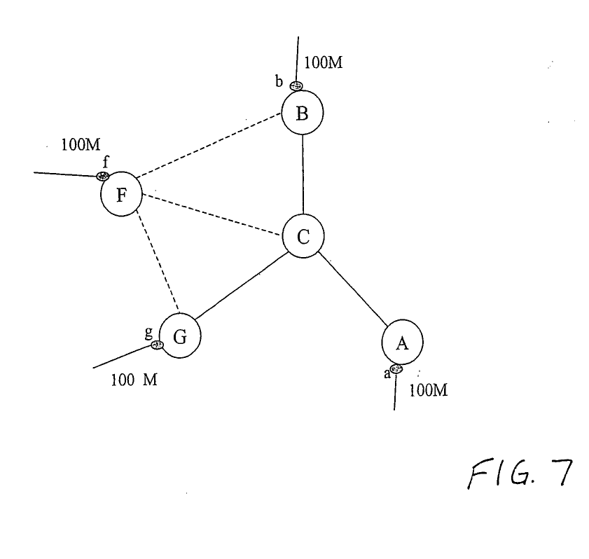

FIG. 7 is a block diagram of an exemplary VLAN that may be implemented utilizing the switches and physical transport lines such as those shown and described in FIG. 3 and is referenced to provide an example of adding a new node. The base VLAN includes nodes A, B, C and G associated with ports a, b and g, as shown. The connections between nodes are referred to as trunks. The new node to be added is shown as node F with an associated port f. Node F may be connected to nodes B, C or G. In a first case, the bandwidth of all ports is considered to be a value of 100. The hub values and total hub value for each potential connection is shown in the table below.

| F connects | Hub | Hub | Hub | Hub | Hub | Total Hub |
|---|---|---|---|---|---|---|
| to | Value A | Value B | Value C | Value G | Value F | Value |
| B | 700 | 500 | 500 | 700 | 700 | 3100 |
| C | 600 | 600 | 400 | 600 | 600 | 2800 |
| G | 700 | 700 | 500 | 500 | 700 | 3100 |

As shown in the example above, the connection yielding the lowest total hub value for all nodes in the VLAN is connecting node F to node C. Thus, this solution is selected.

Next, consider the case where port G has a bandwidth of 1000 rather than 100. The total hub values for each connection scenario are depicted below.

| F connects | Hub | Hub | Hub | Hub | Hub | Total Hub |
|---|---|---|---|---|---|---|
| to | Value A | Value B | Value C | Value G | Value F | Value |
| B | 2500 | 2300 | 1400 | 700 | 3400 | 10300 |
| C | 2400 | 2400 | 1300 | 600 | 2400 | 9100 |
| G | 2500 | 2500 | 1400 | 500 | 1600 | 8500 |

In this example, the connection point providing the lowest total hub value is node G. Thus, new node F is connected to node G and the base VLAN updated accordingly.

Exemplary embodiments of the present invention allow the design and assignment of VLANs to be performed while taking into account a variety of factors including the BW required for each port, the requested COS, the layout of switches and trunks, the requirement for no loops in the VLAN, and the current topology of VLAN. This may lead to better VLAN designs and to more efficient utilization of the underlying trunks and switches. In addition, utilizing exemplary embodiments of the present invention may result in cost savings due to less expert technician time being required to design and assign VLANs.

As described above, the embodiments of the present invention may be embodied in the form of computer-implemented processes and apparatuses for practicing those processes. Embodiments of the present invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Exemplary embodiments of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for facilitating the design and assignment of at least one virtual network, said method comprising:
receiving a request to add a new node to a base virtual network including a number of base nodes;
determining a plurality of potential routes between said new node and said base nodes;
for each potential route determining a virtual network total hub value, said virtual network total hub value being the sum of a hub value for each base node and a hub value for said new node, said hub value being determined for a node in response to bandwidth received at said node multiplied by a number of trunks traversed in reaching said node,
selecting one of said potential routes yielding the minimum virtual network total hub value.

2. The method of claim 1 further comprising:
designing said base virtual network based on a list of routes between pairs of available nodes.

3. The method of claim 2 further comprising:
eliminating routes from consideration in said base virtual network if said route does not include a mandatory hub.

4. The method of claim 2 further comprising:
determining an approximate hub value for said routes in response to route length and route bandwidth;
retrieving a route from said list of routes having a lowest approximate hub value.

5. The method of claim 4 further comprising:
determining if said retrieved route has more than two nodes;
setting said retrieved route as said base virtual network if said retrieved route has only two nodes;
confirming capacity of said retrieved route if said route has more than two nodes.

6. The method of claim 1 wherein:
if multiple potential routes yield the same minimum total hub value, selecting one of said potential routes randomly.

7. The method of claim 1 further comprising:
obtaining a validity factor defining a characteristic of a route; and
eliminating a potential route from consideration if said potential route does not meet said validity factor.

8. A system for facilitating the design and assignment of virtual networks, the system comprising:
an input for receiving a request to add a new node to a base virtual network including a number of base nodes; and
a processor for determining a plurality of potential routes between said new node and said base nodes, wherein for each potential route, the processor determines a virtual network total hub value, said virtual network total hub value being the sum of a hub value for each base node and a hub value for said new node, said hub value being determined for a node in response to bandwidth received at said node multiplied by a number of trunks traversed in reaching said node, and wherein said processor selects one of said potential routes yielding the minimum virtual network total hub value.

9. The system of claim 8 wherein said processor designs said base virtual network based on a list of routes between pairs of available nodes.

10. The system of claim 9 wherein said processor eliminates routes from consideration in said base virtual network if said route does not include a mandatory hub.

11. The system of claim 9 wherein said processor determines an approximate hub value for said routes in response to route length and route bandwidth and retrieves a route from said list of routes having a lowest approximate hub value.

12. The system of claim 11 wherein said processor determines if said retrieved route has more than two nodes, sets said retrieved route as said base virtual network if said retrieved route has only two nodes and confirms capacity of said retrieved route if said route has more than two nodes.

13. The system of claim 8 wherein if multiple potential routes yield the same minimum total hub value, the processor selects one of said potential routes randomly.

14. The system of claim 8 wherein the processor obtains a validity factor defining a characteristic of a route and eliminates a potential route from consideration if said potential route does not meet said validity factor.

15. A computer program product for facilitating the design and assignment of virtual networks, the computer program product comprising:
a storage medium readable by a processing circuit and storing instructions for execution by the processing circuit for implementing a method comprising:
receiving a request to add a new node to a base virtual network including a number of base nodes;
determining a plurality of potential routes between said new node and said base nodes;
for each potential route determining a virtual network total hub value, said virtual network total hub value being the sum of a hub value for each base node and a hub value for said new node, said hub value being determined for a node in response to bandwidth received at said node multiplied by a number of trunks traversed in reaching said node,
selecting one of said potential routes yielding the minimum virtual total hub value.

16. The computer program product of claim 15 further comprising:
instructions for execution by the processing circuit for implementing:
designing said base virtual network based on a list of routes between pairs of available nodes.

17. The computer program product of claim 16 further comprising:
instructions for execution by the processing circuit for implementing:
eliminating routes from consideration in said base VLAN if said route does not include a mandatory hub.

18. The computer program product of claim 16 further comprising:
instructions for execution by the processing circuit for implementing:
determining an approximate hub value for said routes in response to route length and route bandwidth;
retrieving a route from said list of routes having a lowest approximate hub value.

19. The computer program product of claim 18 further comprising:
instructions for execution by the processing circuit for implementing:
determining if said retrieved route has more than two nodes;
setting said retrieved route as said base virtual network if said retrieved route has only two nodes;
confirming capacity of said retrieved route if said route has more than two nodes.

20. The computer program product of claim 19 further comprising:
instructions for execution by the processing circuit for implementing:
if multiple potential routes yield the same minimum total hub value, selecting one of said potential routes randomly.

21. The computer program product of claim 15 further comprising:
instructions for execution by the processing circuit for implementing:
obtaining a validity factor defining a characteristic of a route; and
eliminating a potential route from consideration if said potential route does not meet said validity factor.
